(19) United States
(12) Patent Application Publication
(10) Pub. No.: US 2022/0033229 A1
(43) Pub. Date: Feb. 3, 2022

(54) BEAM CLIMBER ASSEMBLY POD FOR GUIDE RAIL AND GUIDE BEAM INSTALLATION

(71) Applicant: Otis Elevator Company, Farmington, CT (US)

(72) Inventor: Randy Roberts, Hebron, CT (US)

(21) Appl. No.: 16/940,912

(22) Filed: Jul. 28, 2020

(51) Int. Cl. B66B 19/00; B66B 9/02

(52) U.S. Cl. CPC B66B 19/002; B66B 9/02

(57) ABSTRACT

An elevator system including: an elevator car configured to move through an elevator shaft; a first guide beam extending vertically through the elevator shaft, the first guide beam including a first surface and a second surface opposite the first surface, wherein the first guide beam includes a first section; a beam climber system configured to move the elevator car through the elevator shaft, the beam climber system including: a first wheel in contact with the first surface; and a first electric motor configured to rotate the first wheel; and a beam climber assembly pod operably attached to the beam climber system, wherein the beam climber assembly pod is configured construct remaining sections of the first guide beam as the beam climber assembly rides on the first section of the first guide beam.

### BACKGROUND

The subject matter disclosed herein relates generally to the field of elevator systems, and specifically to a method and apparatus for building an elevator system.

Elevator cars are conventionally operated by ropes and counter weights, which typically only allow one elevator car in an elevator shaft at a single time. The elevator cars are guided through the elevator shaft by guide rails. Construction of guide rails for elevator systems is conventionally performed manually by human beings.

### BRIEF SUMMARY

According to an embodiment, an elevator system is provided. The elevator system including: an elevator car configured to move through an elevator shaft; a first guide beam extending vertically through the elevator shaft, the first guide beam including a first surface and a second surface opposite the first surface, wherein the first guide beam includes a first section; a beam climber system configured to move the elevator car through the elevator shaft, the beam climber system including: a first wheel in contact with the first surface; and a first electric motor configured to rotate the first wheel; and a beam climber assembly pod operably attached to the beam climber system, wherein the beam climber assembly pod is configured construct remaining sections of the first guide beam as the beam climber assembly rides on the first section of the first guide beam.

In addition to one or more of the features described herein, or as an alternative, further embodiments may include that the beam climber assembly pod further includes a first lifting system configured to releasably attach to a second section of the first guide beam.

In addition to one or more of the features described herein, or as an alternative, further embodiments may include that the beam climber system is configured to move the beam climber assembly pod to a location in the elevator shaft where the second section of the first guide beam may be attached to the first section of the first guide beam.

In addition to one or more of the features described herein, or as an alternative, further embodiments may include that the first lifting system includes a pulley and a pulley cable.

In addition to one or more of the features described herein, or as an alternative, further embodiments may include that the first lifting system includes at least one of a robotic arm, a hydraulic or pneumatic ram, a linear actuator, a hydraulic cylinder, a linear motor, or a miniature belt driven system with CSB belts.

In addition to one or more of the features described herein, or as an alternative, further embodiments may include a first guide rail extending vertically through the elevator shaft, the first guide rail including a first section of the first guide rail, wherein the beam climber assembly pod further includes a first lifting system configured to releasably attach to a second section of the first guide rail.

In addition to one or more of the features described herein, or as an alternative, further embodiments may include that the beam climber assembly pod is configured construct remaining sections of the first guide rail as the beam climber assembly rides on the first section of the first guide beam.

In addition to one or more of the features described herein, or as an alternative, further embodiments may include that the beam climber system is configured to move the beam climber assembly pod to a location in the elevator shaft where the second section of the first guide rail may be attached to the first section of the first guide rail.

In addition to one or more of the features described herein, or as an alternative, further embodiments may include that the first lifting system includes a pulley and a pulley cable.

In addition to one or more of the features described herein, or as an alternative, further embodiments may include: a second guide beam extending vertically through the elevator shaft, the second guide beam including a first surface of the second guide beam and a second surface of the second guide beam opposite the first surface of the second guide beam, wherein the second guide beam includes a first section of the second guide beam, wherein the beam climber system further includes: a second wheel in contact with the second surface of the first guide beam; and a third wheel in contact with the first surface of the second guide beam, and wherein the beam climber assembly pod further includes a second lifting system configured to releasably attach to a second section of the second guide beam.

In addition to one or more of the features described herein, or as an alternative, further embodiments may include that the beam climber assembly pod is configured construct remaining sections of the second guide beam as the beam climber assembly rides on the first section of the first guide beam.

In addition to one or more of the features described herein, or as an alternative, further embodiments may include that the beam climber system is configured to move the beam climber assembly pod to a location in the elevator shaft where the second section of the second guide beam may be attached to the first section of the second guide beam.

In addition to one or more of the features described herein, or as an alternative, further embodiments may include that the second lifting system includes a pulley and a pulley cable.

In addition to one or more of the features described herein, or as an alternative, further embodiments may include that the beam climber assembly pod further includes a work stand.

According to another embodiment, a method of building an elevator system is provided. The method including: removably attaching a second section of a first guide beam to a first lifting system of a beam climber assembly pod; rotating, using a first electric motor of a beam climber system, a first wheel, the first wheel being in contact with a first surface of the first guide beam that extends vertically through an elevator shaft, the first guide beam including a first section of the first guide beam; moving, using the beam climber system, the beam climber assembly pod through the elevator shaft when the first wheel of the beam climber system rotates along the first surface of the first section of the first guide beam, wherein the beam climber system moves the beam climber assembly pod to a location in the elevator shaft where the second section of the first guide beam may be attached to the first section of the first guide beam.

In addition to one or more of the features described herein, or as an alternative, further embodiments may include removably attaching a second section of a second guide beam to a second lifting system of the beam climber assembly pod, wherein the beam climber system moves the beam climber assembly pod to a location in the elevator shaft where the second section of the second guide beam may be attached to a first section of the second guide beam.

In addition to one or more of the features described herein, or as an alternative, further embodiments may include: removably attaching a second section of a second guide beam to a second lifting system of the beam climber assembly pod, wherein the beam climber system further includes a second wheel in contact with the second surface of the first guide beam; and rotating, using a second electric motor of a beam climber system, a third wheel, the third wheel being in contact with a first surface of a second guide beam that extends vertically through an elevator shaft, the second guide beam including a first section of the second guide beam; wherein the beam climber system moves the beam climber assembly pod to a location in the elevator shaft where the second section of the second guide beam may be attached to a first section of the second guide beam.

In addition to one or more of the features described herein, or as an alternative, further embodiments may include that the elevator system further includes a first guide rail extending vertically through the elevator shaft, the first guide rail including a first section of the first guide rail, and wherein the method further includes: removably attaching a second section of the first guide rail to the first lifting system of the beam climber assembly pod, wherein the beam climber system moves the beam climber assembly pod to a location in the elevator shaft where the second section of the first guide rail may be attached to a first section of the first guide rail.

In addition to one or more of the features described herein, or as an alternative, further embodiments may include that the elevator system further includes a first guide rail extending vertically through the elevator shaft, the first guide rail including a first section of the first guide rail, and wherein the method further includes: removably attaching a second section of the first guide rail to the first lifting system of the beam climber assembly pod, wherein the beam climber system moves the beam climber assembly pod to a location in the elevator shaft where the second section of the first guide rail may be attached to a first section of the first guide rail.

In addition to one or more of the features described herein, or as an alternative, further embodiments may include that the elevator system further includes a second guide rail extending vertically through the elevator shaft, the second guide rail including a first section of the second guide rail, and wherein the method further includes: removably attaching a second section of the second guide rail to a second lifting system of the beam climber assembly pod, wherein the beam climber system moves the beam climber assembly pod to a location in the elevator shaft where the second section of the second guide rail may be attached to a first section of the second guide rail.

Technical effects of embodiments of the present disclosure include utilizing a beam climber system to build multiple guide beams and guide rails that the beam climber system rides upon as the beam climber system build.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system with a beam climber system, in accordance with an embodiment of the disclosure;

FIG. 2A illustrates a schematic view of a beam climber assembly pod building the elevator system, in accordance with an embodiment of the disclosure;

FIG. 2B illustrates a schematic view of the beam climber assembly pod building the elevator system, in accordance with an embodiment of the disclosure;

FIG. 2C illustrates a schematic view of the beam climber assembly pod building the elevator system, in accordance with an embodiment of the disclosure;

FIG. 2D illustrates a schematic view of the beam climber assembly pod building the elevator system, in accordance with an embodiment of the disclosure;

FIG. 2E illustrates a schematic view of the beam climber assembly pod building the elevator system, in accordance with an embodiment of the disclosure;

FIG. 2F illustrates a schematic view of the beam climber assembly pod building the elevator system, in accordance with an embodiment of the disclosure; and

FIG. 3 is a flow chart of method of assembling the elevator system, in accordance with an embodiment of the disclosure.

### DETAILED DESCRIPTION

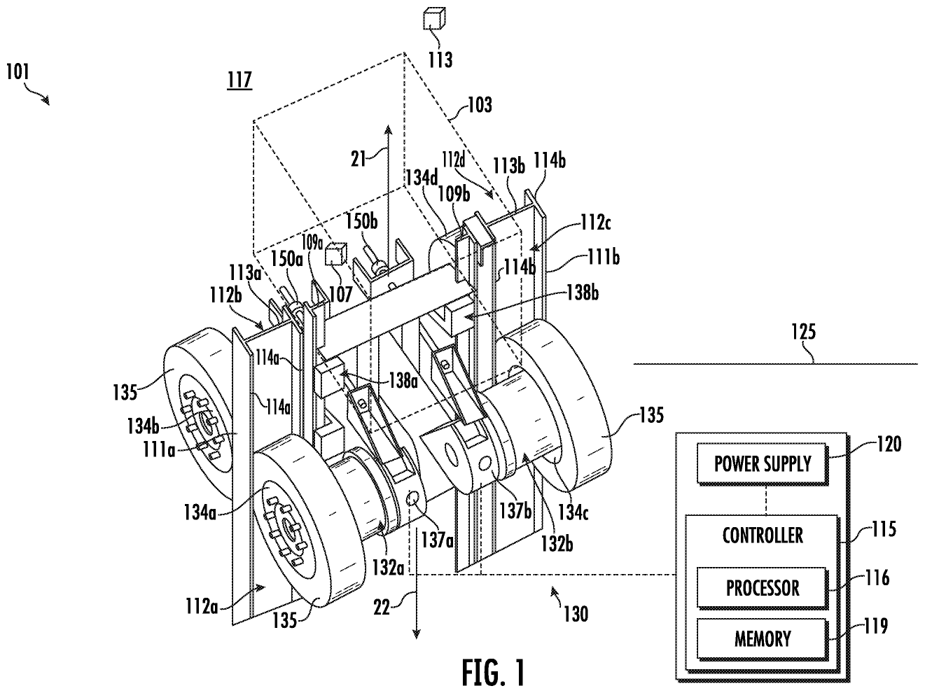

FIG. 1 is a perspective view of an elevator system 101 including an elevator car 103, a beam climber system 130, a controller 115, and a power supply 120. Although illustrated in FIG. 1 as separate from the beam climber system 130, the embodiments described herein may be applicable to a controller 115 included in the beam climber system 130 (i.e., moving through an elevator shaft 117 with the beam climber system 130) and may also be applicable to a controller located off of the beam climber system 130 (i.e., remotely connected to the beam climber system 130 and stationary relative to the beam climber system 130). Although illustrated in FIG. 1 as separate from the beam climber system 130, the embodiments described herein may be applicable to a power supply 120 included in the beam climber system 130 (i.e., moving through the elevator shaft 117 with the beam climber system 130) and may also be applicable to a power supply located off of the beam climber system 130 (i.e., remotely connected to the beam climber system 130 and stationary relative to the beam climber system 130).

The beam climber system 130 is configured to move the elevator car 103 within the elevator shaft 117 and along guide rails 109a, 109b that extend vertically through the elevator shaft 117. In an embodiment, the guide rails 109a, 109b are T-beams. The beam climber system 130 includes one or more electric motors 132a, 132b. The electric motors 132a, 132b are configured to move the beam climber system 130 within the elevator shaft 117 by rotating one or more wheels 134a, 134b that are pressed against a guide beam 111a, 111b. In an embodiment, the guide beams 111a, 111b are I-beams. It is understood that while an I-beam is illustrated any beam or similar structure may be utilized with the embodiment described herein. Friction between the wheels 134a, 134b, 134c, 134d driven by the electric motors 132a, 132b allows the wheels 134a, 134b, 134c, 134d climb up 21 and down 22 the guide beams 111a, 111b. The guide beam extends vertically through the elevator shaft 117. It is understood that while two guide beams 111a, 111b are illustrated, the embodiments disclosed herein may be utilized with one or more guide beams. It is also understood that while two electric motors 132a, 132b are illustrated, the embodiments disclosed herein may be applicable to beam climber systems 130 having one or more electric motors. For example, the beam climber system 130 may have one electric motor for each of the four wheels 134a, 134b, 134c, 134d. The electric motors 132a, 132b may be permanent magnet electric motors, asynchronous motor, or any electric motor known to one of skill in the art. In other embodiments, not illustrated herein, another configuration could have the powered wheels at two different vertical locations (i.e., at bottom and top of an elevator car 103).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto the web portion 113a of the first guide beam 111a. The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method. The first compression mechanism 150a may be adjustable in real-time during operation of the elevator system 101 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the elevator shaft 117, thus creating a track for the first wheel 134a and the second wheel 134b to ride on. The flange portions 114a may work as guardrails to help guide the wheels 134a, 134b along this track and thus help prevent the wheels 134a, 134b from running off track.

The first electric motor 132a is configured to rotate the first wheel 134a to climb up 21 or down 22 the first guide beam 111a. The first electric motor 132a may also include a first motor brake 137a to slow and stop rotation of the first electric motor 132a. The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 103. The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b. The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 101 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the elevator shaft 117, thus creating a track for the third wheel 134c and the fourth wheel 134d to ride on. The flange portions 114b may work as guardrails to help guide the wheels 134c, 134d along this track and thus help prevent the wheels 134c, 134d from running off track.

The second electric motor 132b is configured to rotate the third wheel 134c to climb up 21 or down 22 the second guide beam 111b. The second electric motor 132b may also include a second motor brake 137b to slow and stop rotation of the second motor 132b. The second motor brake 137b may be mechanically connected to the second motor 132b. The second motor brake 137b may be a clutch system, a disc brake system, drum brake system, a brake on a rotor of the second electric motor 132b, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109 proximate the elevator car 103. The elevator system 101 may also include a position reference system 113. The position reference system 113 may be mounted on a fixed part at the top of the elevator shaft 117, such as on a support or guide rail 109, and may be configured to provide position signals related to a position of the elevator car 103 within the elevator shaft 117. In other embodiments, the position reference system 113 may be directly mounted to a moving component of the elevator system (e.g., the elevator car 103 or the beam climber system 130), or may be located in other positions and/or configurations as known in the art. The position reference system 113 can be any device or mechanism for monitoring a position of an elevator car within the elevator shaft 117, as known in the art. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 103 and the beam climber system 130. For example, the controller 115 may provide drive signals to the beam climber system 130 to control the acceleration, deceleration, leveling, stopping, etc. of the elevator car 103.

The controller 115 may also be configured to receive position signals from the position reference system 113 or any other desired position reference device.

When moving up 21 or down 22 within the elevator shaft 117 along the guide rails 109a, 109b, the elevator car 103 may stop at one or more landings 125 as controlled by the controller 115. In one embodiment, the controller 115 may be located remotely or in the cloud. In another embodiment, the controller 115 may be located on the beam climber system 130

The power supply 120 for the elevator system 101 may be any power supply, including a power grid and/or battery power which, in combination with other components, is supplied to the beam climber system 130. In one embodiment, power supply 120 may be located on the beam climber system 130. In an embodiment, the power supply 120 is a battery that is included in the beam climber system 130.

The elevator system 101 may also include an accelerometer 107 attached to the elevator car 103 or the beam climber system 130. The accelerometer 107 is configured to detect an acceleration and/or a speed of the elevator car 103 and the beam climber system 130.

The embodiments disclosed herein relate to a method and apparatus for building new guide beam 111 and guide rail 109 section using the beam climber system 130 as the beam climber system 130 rides on previously installed guide beam 111 and guide rails 109 sections.

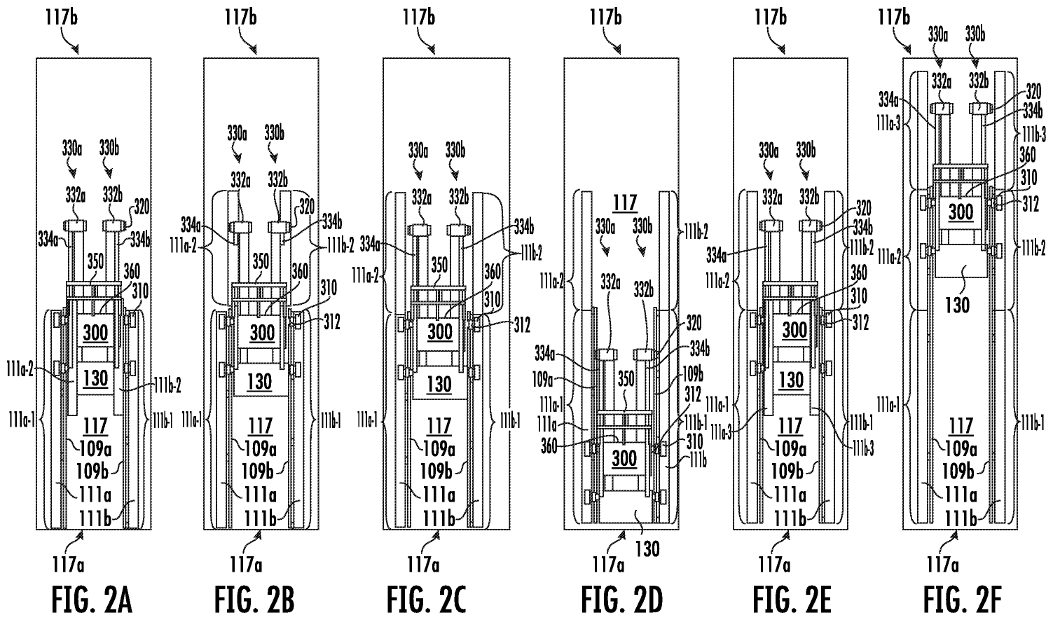

Referring now to FIGS. 2A, 2B, 2C, 2D, 2E, 2F, with continued reference to FIG. 1, a beam climber assembly pod 300 for guide rails 109a, 109b and guide beams 111a, 111b is illustrated, in accordance with an embodiment of the present disclosure. FIGS. 2A, 2B, 2C, 2D, 2E, 2F illustrate how the beam climber assembly pod 300 builds the guide rails 109a, 109b and guide beams 111a, 111b from a bottom 117a of the elevator shaft 117 to a top 117b of the elevator shaft 117, as illustrated in FIG. 2A moving to FIG. 2F.

The beam climber assembly pod 300 is operably attached to the beam climber system 130. The beam climber assembly pod 300 may be located on top of the beam climber system 130, as illustrated in FIGS. 2A, 2B, 2C, 2D, 2E, 2F. The beam climber assembly pod 300 may include a support beam 320 and a first lifting system 330a and a second lifting system 330b. The first lifting system 330a and the second lifting system 330b may be attached to the support beam 320. In an embodiment, the first lifting system 330a and the second lifting system 330b may be a pulley system. The first lifting system 330a may comprise a first pulley 332a and a first pulley cable 334a. The second lifting system 330b may comprise a second pulley 332b and a second pulley cable 334b. In one embodiment, there may be a single first lifting system 330a. In one embodiment, there may be more than two lifting systems.

It is understood, that while a pulley system is utilized herein for exemplarily illustration, the embodiment disclosed herein may be applicable to other lifting systems, such as, for example a robotic arm, a hydraulic or pneumatic ram, a linear actuator, a hydraulic cylinder, a linear motor, a miniature belt driven system with CSB belts, or any other known method of lifting an object. In another embodiment, the first lifting system 330a and the second lifting system 330b may be robotic arms. In another embodiment, the first lifting system 330a and/or the second lifting system 330b comprises at least one of a robotic arm, a hydraulic or pneumatic ram, a linear actuator, a hydraulic cylinder, a linear motor, or a miniature belt driven system with CSB belts.

As illustrated in FIG. 2A, a first section 111a-1 of the first guide beam 111a may prebuilt in the elevator shaft 117 for the beam climber system 130 and the beam climber assembly pod 300 to ride on as the beam climber assembly pod 300 constructs the remaining sections 111a-2, 111a-3 of the first guide beam 111a. The remaining sections 111a-2, 111a-3 of the first guide beam 111a may include a second section 111a-2 of the first guide beam 111a and a third section 111a-3 of the first guide beam 111a. It is understood that while only two remaining sections 111a-2, 111a-3 of the first guide beam 111a are being built by the beam climber assembly pod 300 as further described herein, the embodiments disclosed herein may be applicable to a beam climber assembly pod 300 building any number of sections for the first guide beam 111a.

As illustrated in FIG. 2A, a first section 111b-1 of the second guide beam 111b may prebuilt in the elevator shaft 117 for the beam climber system 130 and the beam climber assembly pod 300 to ride on as the beam climber assembly pod 300 constructs the remaining sections 111b-2, 111b-3 of the second guide beam 111b. The remaining sections 111b-2, 111b-3 of the second guide beam 111b may include a second section 111b-2 of the second guide beam 111b and a third section 111b-3 of the second guide beam 111b. It is understood that while only two remaining sections 111b-2, 111b-3 of the second guide beam 111b are being built by the beam climber assembly pod 300 as further described herein, the embodiments disclosed herein may be applicable to a beam climber assembly pod 300 building any number of sections for the second guide beam 111b.

As illustrated in FIG. 2A, a first section 109a-1 of the first guide rail 109a may prebuilt in the elevator shaft 117 to guide the beam climber system 130 and the beam climber assembly pod 300 as the beam climber assembly pod 300 constructs the remaining sections 109a-2, 109a-3 of the first guide rail 109a. The remaining sections 109a-2, 109a-3 of the first guide rail 109a may include a second section 109a-2 of the first guide rail 109a and a third section 109a-3 of the first guide rail 109a. It is understood that while only two remaining sections 109a-2, 109a-3 of the first guide rail 109a are being built by the beam climber assembly pod 300 as further described herein, the embodiments disclosed herein may be applicable to a beam climber assembly pod 300 building any number of sections for the first guide rail 109a.

As illustrated in FIG. 2A, a first section 109b-1 of the second guide rail 109b may prebuilt in the elevator shaft 117 to guide the beam climber system 130 and the beam climber assembly pod 300 as the beam climber assembly pod 300 constructs the remaining sections 109b-2, 109b-3 of the second guide rail 109b. The remaining sections 109b-2, 109b-3 of the second guide rail 109b may include a second section 109b-2 of the second guide rail 109b and a third section 109b-3 of the second guide rail 109b. It is understood that while only two remaining sections 109b-2, 109b-3 of the second guide rail 109b are being built by the beam climber assembly pod 300 as further described herein, the embodiments disclosed herein may be applicable to a beam climber assembly pod 300 any number of sections for the second guide rail 109b.

The beam climber assembly pod 300 may also include wheels 310 to ride on the first guide beam 111a and the second guide beam 111b. The beam climber assembly pod 300 may include two wheels 310 or four wheels 310, in a configuration similar to the beam climber systems 130, such as, for example, two wheels 310 compressing the first guide beam 111a and two wheels 310 compressing the second beam guide beam 111b. The beam climber assembly pod 300 may include additional electric motors 312, similar to the beam climber systems 130, to rotate the wheels 310 of the beam climber assembly pod 300, thus increasing the torque and climbing power, resulting in larger lifting capacity.

As illustrated in FIG. 2A, the first lifting system 330a is configured to releasably attach to (i.e., grab) the second section 111a-2 of the first guide beam 111a and the second section 109a-2 of the first guide rail 109a proximate the bottom 117a of the elevator shaft 117 or any other starting location. The first pulley cable 334a may include a claw mechanism (not shown for simplicity) or similar mechanism to grab on to the second section 111a-2 of the first guide beam 111a and the second section 109a-2 of the first guide rail 109a. The beam climber system 130 is then configured to move the beam climber assembly pod 330 up to a location where the second section 111a-2 of the first guide beam 111a and the second section 109a-2 of the first guide rail 109a are to be installed, as illustrated in FIG. 2B. Then a worker standing on a work stand 360 of beam climber assembly pod 300 will attach the second section 111a-2 of the first guide beam 111a to the first section 111a-1 of the first guide beam 111a and the second section 109a-2 of the first guide rail 109a to the first section 109a-1 of the first guide rail 109a. The work stand 360 may include a safety rail 350 to keep the worker safely on the work stand 360. Alternatively, a robotic system can attach the second section 111a-2 of the first guide beam 111a to the first section 111a-1 of the first guide beam 111a and the second section 109a-2 of the first guide rail 109a to the first section 109a-1 of the first guide rail 109a. FIG. 2C illustrates, the second section 111a-2 of the first guide beam 111a attached to the first section 111a-1 of the first guide beam 111a and the second section 109a-2 of the first guide rail 109a attached to the first section 109a-1 of the first guide rail 109a.

As illustrated in FIG. 2A, the second lifting system 330b is configured to releasably attach to (i.e., grab) the second section 111b-2 of the second guide beam 111b and the second section 109b-2 of the second guide rail 109b proximate the bottom 117a of the elevator shaft 117 or any other starting location. The second pulley cable 334b may include a claw mechanism (not shown for simplicity) or similar mechanism to grab on to the second section 111b-2 of the second guide beam 111b and the second section 109b-2 of the second guide rail 109b. The beam climber system 130 is then configured to move the beam climber assembly pod 330 up to a location where the second section 111b-2 of the second guide beam 111b and the second section 109b-2 of the second guide rail 109b are to be installed, as illustrated in FIG. 2B. Then a worker standing on a work stand 360 of beam climber assembly pod 300 will attach the second section 111b-2 of the second guide beam 111b to the first section 111b-1 of the second guide beam 111b and the second section 109b-2 of the second guide rail 109b to the first section 109b-1 of the second guide rail 109b. Alternatively, a robotic system can attach the second section 111b-2 of the second guide beam 111b to the first section 111b-1 of the second guide beam 111b and the second section 109b-2 of the second guide rail 109b to the first section 109b-1 of the second guide rail 109b. FIG. 2C illustrates, the second section 111b-2 of the second guide beam 111b attached to the first section 111b-1 of the second guide beam 111b and the second section 109b-2 of the second guide rail 109b attached to the first section 109b-1 of the second guide rail 109b.

As shown in FIG. 2D, the beam climber system 130 may be configured to move back down to the bottom 117a of the elevator shaft 117 once the second section 111a-2 of the first guide beam 111a is attached to the first section 111a-1 of the first guide beam 111a, the second section 109a-2 of the first guide rail 109a is attached to the first section 109a-1 of the first guide rail 109a, the second section 111b-2 of the second guide beam 111b is attached to the first section 111b-1 of the second guide beam 111b, and the second section 109b-2 of the second guide rail 109b is attached to the first section 109b-1 of the second guide rail 109b.

As shown in FIG. 2E, the first lifting system 330a is configured to releasably attach to (i.e., grab) the third section 111a-3 of the first guide beam 111a and the third section 109a-3 of the first guide rail 109a proximate the bottom 117a of the elevator shaft 117 or any other starting location. The first pulley cable 334a may include a claw mechanism (not shown for simplicity) or similar mechanism to grab on to the third section 111a-3 of the first guide beam 111a and the third section 109a-3 of the first guide rail 109a. The beam climber system 130 is then configured to move the beam climber assembly pod 330 up to a location where the third section 111a-3 of the first guide beam 111a and the third section 109a-3 of the first guide rail 109a are to be installed, as illustrated in FIGS. 2E and 2F. Then a worker standing on the work stand 360 of beam climber assembly pod 300 will attach the third section 111a-3 of the first guide beam 111a to the second section 111a-2 of the first guide beam 111a and the third section 109a-3 of the first guide rail 109a to the second section 109a-2 of the first guide rail 109a. Alternatively, a robotic system can attach the third section 111a-3 of the first guide beam 111a to the second section 111a-2 of the first guide beam 111a and the third section 109a-3 of the first guide rail 109a to the second section 109a-2 of the first guide rail 109a. FIG. 2F illustrates, the third section 111a-3 of the first guide beam 111a attached to the second section 111a-2 of the first guide beam 111a and the third section 109a-3 of the first guide rail 109a attached to the second section 109a-2 of the first guide rail 109a.

As illustrated in FIG. 2E, the second lifting system 330b is configured to releasably attach to (i.e., grab) the third section 111b-3 of the second guide beam 111b and the third section 109b-3 of the second guide rail 109b proximate the bottom 117a of the elevator shaft 117 or any other starting location. The second pulley cable 334b may include a claw mechanism (not shown for simplicity) or similar mechanism to grab on to the third section 111b-3 of the second guide beam 111b and the third section 109b-3 of the second guide rail 109b. The beam climber system 130 is then configured to move the beam climber assembly pod 330 up to a location where the third section 111b-3 of the second guide beam 111b and the third section 109b-3 of the second guide rail 109b are to be installed, as illustrated in FIGS. 2E and 2F. Then a worker standing on a work stand 360 of beam climber assembly pod 300 will attach the third section 111b-3 of the second guide beam 111b to the second section 111b-2 of the second guide beam 111b and the third section 109b-3 of the second guide rail 109b to the second section 109b-2 of the second guide rail 109b. Alternatively, a robotic system can attach the third section 111b-3 of the second guide beam 111b to the second section 111b-2 of the second guide beam 111b and the third section 109b-3 of the second guide rail 109b to the second section 109b-2 of the second guide rail 109b. FIG. 2F illustrates, the third section 111b-3 of the second guide beam 111b attached to the second section 111b-2 of the second guide beam 111b and the third section 109b-3 of the second guide rail 109b attached to the second section 109b-2 of the second guide rail 109b.

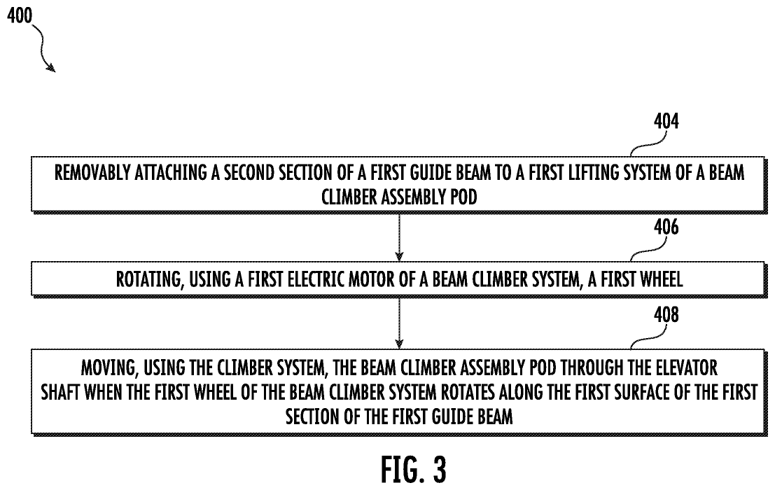

Referring now to FIG. 3, with continued reference to the previous FIGS., a flow chart of method 400 of building an elevator systems 101 is illustrated, in accordance with an embodiment of the disclosure.

At block 404, a second section 111a-2 of a first guide beam 111a is removably attached to a first lifting system 330a of a beam climber assembly pod 300.

At block 406, a first electric motor 132a of a beam climber system 130 rotates a first wheel 134a. The first wheel 134a being in contact with a first surface 112a of the first guide beam 111a that extends vertically through an elevator shaft 117. The first guide beam comprising a first section of the first guide beam.

At block 408, the beam climber system 130 moves the beam climber assembly pod 300 through the elevator shaft 117 when the first wheel 134a of the beam climber system 130 rotates along the first surface 112a of the first section 111a-1 of the first guide beam 111a. The beam climber system 130 moves the beam climber assembly pod 300 to a location in the elevator shaft 117 where the second section 111a-2 of the first guide beam 111a may be attached to the first section 111a-1 of the first guide beam 111a.

The method 400 may further include removably attaching a second section 111b-2 of a second guide beam 111b to a second lifting system 330b of the beam climber assembly pod 300. The beam climber system 130 moves the beam climber assembly pod 300 to a location in the elevator shaft 117 where the second section 111b-2 of the second guide beam 111b may be attached to a first section 111b-1 of the second guide beam 111b.

The method 400 may also include removably attaching a second section of a second guide beam to a second lifting system of the beam climber assembly pod 300. The beam climber system 130 further comprises a second wheel 134b in contact with the second surface 112b of the first guide beam 111a. The method 400 may also include rotating, using a second electric motor of a beam climber system 130, a third wheel. The third wheel 134c being in contact with a first surface 112c of a second guide beam 111b that extends vertically through an elevator shaft 117. The second guide beam 111b comprising a first section 111b-1 of the second guide beam 111b. The beam climber system 130 moves the beam climber assembly pod 300 to a location in the elevator shaft 117 where the second section 111b-2 of the second guide beam 111b may be attached to a first section 111b-1 of the second guide beam 111b.

The elevator system 101 may further include a first guide rail 109a extending vertically through the elevator shaft 117. The first guide rail 109a comprising a first section 109a-1 of the first guide rail 109a. The method 400 may also include removably attaching a second section 109a-2 of the first guide rail 109a to the first lifting system 330a of the beam climber assembly pod 300. The beam climber system 130 moves the beam climber assembly pod 300 to a location in the elevator shaft 117 where the second section 109a-2 of the first guide rail 109a may be attached to a first section 109a-1 of the first guide rail 109a.

The elevator system 101 may further include a second guide rail 109b extending vertically through the elevator shaft 117. The second guide rail 109b comprising a first section 109b-1 of the second guide rail 109b. The method 400 may further include removably attaching a second section 109b-2 of the second guide rail 109b to a second lifting system 330b of the beam climber assembly pod 300. The beam climber system 130 moves the beam climber assembly pod 300 to a location in the elevator shaft 117 where the second section 109b-2 of the second guide rail 109b may be attached to a first section 109b-1 of the second guide rail 109b.

The method 400 may include additionally or alternatively the following process. First the beam climber assembly pod 300 is parked and locked at a bottom of the elevator shaft 117 where it loads and secures loose guide beam 111 and guide rails 109 for vertical transport. Next the beam climber assembly pod 300 moves up to the top section of previously installed guide beam 111 and guide rails 109, secures itself, and verifies “safe to lift” condition. Next, the loose guide beam 111 and guide rails 109 are hoisted vertically upward to connect to previously installed guide beam 111 and guide rails 109 and mechanics secure the connection at both the bottom and top of the newly assembled guide beam 111 and guide rails 109. The beam climber assembly pod 300 then disconnects from the newly assembled guide beam 111 and guide rails 109 and confirms it is safe to move. Next beam climber assembly pod 300 moves back down to the bottom of the elevator shaft 117 to pick up another set of beams to be installed. This process is repeated until the full rise of the elevator hoistway 117 is completed with installed guide beams 111 and guide rails 109

While the above description has described the flow process of FIG. 3 in a particular order, it should be appreciated that unless otherwise specifically required in the attached claims that the ordering of the steps may be varied.

The present invention may be a system, a method, and/or a computer program product at any possible technical detail level of integration. The computer program product may include a computer readable storage medium (or media) having computer readable program instructions thereon for causing a processor to carry out aspects of the present invention.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system comprising:
an elevator car configured to move through an elevator shaft;
a first guide beam extending vertically through the elevator shaft, the first guide beam comprising a first surface and a second surface opposite the first surface, wherein the first guide beam comprises a first section;
a beam climber system configured to move the elevator car through the elevator shaft, the beam climber system comprising:
a first wheel in contact with the first surface; and
a first electric motor configured to rotate the first wheel; and
a beam climber assembly pod operably attached to the beam climber system, wherein the beam climber assembly pod is configured construct remaining sections of the first guide beam as the beam climber assembly rides on the first section of the first guide beam.

2. The elevator system of claim 1, wherein the beam climber assembly pod further comprises a first lifting system configured to releasably attach to a second section of the first guide beam.

3. The elevator system of claim 2, wherein the beam climber system is configured to move the beam climber assembly pod to a location in the elevator shaft where the second section of the first guide beam may be attached to the first section of the first guide beam.

4. The elevator system of claim 2, wherein the first lifting system comprises a pulley and a pulley cable.

5. The elevator system of claim 2, wherein the first lifting system comprises at least one of a robotic arm, a hydraulic or pneumatic ram, a linear actuator, a hydraulic cylinder, a linear motor, or a miniature belt driven system with CSB belts.

6. The elevator system of claim 1, further comprising:
a first guide rail extending vertically through the elevator shaft, the first guide rail comprising a first section of the first guide rail,
wherein the beam climber assembly pod further comprises a first lifting system configured to releasably attach to a second section of the first guide rail.

7. The elevator system of claim 6, wherein the beam climber assembly pod is configured construct remaining sections of the first guide rail as the beam climber assembly rides on the first section of the first guide beam.

8. The elevator system of claim 6, wherein the beam climber system is configured to move the beam climber assembly pod to a location in the elevator shaft where the second section of the first guide rail may be attached to the first section of the first guide rail.

9. The elevator system of claim 6, wherein the first lifting system comprises a pulley and a pulley cable.

10. The elevator system of claim 1, further comprising:
a second guide beam extending vertically through the elevator shaft, the second guide beam comprising a first surface of the second guide beam and a second surface of the second guide beam opposite the first surface of the second guide beam, wherein the second guide beam comprises a first section of the second guide beam,
wherein the beam climber system further comprises:
a second wheel in contact with the second surface of the first guide beam; and
a third wheel in contact with the first surface of the second guide beam, and
wherein the beam climber assembly pod further comprises a second lifting system configured to releasably attach to a second section of the second guide beam.

11. The elevator system of claim 10, wherein the beam climber assembly pod is configured construct remaining sections of the second guide beam as the beam climber assembly rides on the first section of the first guide beam.

12. The elevator system of claim 10, wherein the beam climber system is configured to move the beam climber assembly pod to a location in the elevator shaft where the second section of the second guide beam may be attached to the first section of the second guide beam.

13. The elevator system of claim 10, wherein the second lifting system comprises a pulley and a pulley cable.

14. The elevator system of claim 10, wherein the beam climber assembly pod further comprises a work stand.

15. A method of building an elevator system, the method comprising:
removably attaching a second section of a first guide beam to a first lifting system of a beam climber assembly pod;
rotating, using a first electric motor of a beam climber system, a first wheel, the first wheel being in contact with a first surface of the first guide beam that extends vertically through an elevator shaft, the first guide beam comprising a first section of the first guide beam; and
moving, using the beam climber system, the beam climber assembly pod through the elevator shaft when the first wheel of the beam climber system rotates along the first surface of the first section of the first guide beam, wherein the beam climber system moves the beam climber assembly pod to a location in the elevator shaft where the second section of the first guide beam may be attached to the first section of the first guide beam.

16. The method of claim 15, further comprising:
removably attaching a second section of a second guide beam to a second lifting system of the beam climber assembly pod, wherein the beam climber system moves the beam climber assembly pod to a location in the elevator shaft where the second section of the second guide beam may be attached to a first section of the second guide beam.

17. The method of claim 15, further comprising:
removably attaching a second section of a second guide beam to a second lifting system of the beam climber assembly pod, wherein the beam climber system further comprises a second wheel in contact with the second surface of the first guide beam; and
rotating, using a second electric motor of a beam climber system, a third wheel, the third wheel being in contact with a first surface of a second guide beam that extends vertically through an elevator shaft, the second guide beam comprising a first section of the second guide beam;
wherein the beam climber system moves the beam climber assembly pod to a location in the elevator shaft where the second section of the second guide beam may be attached to a first section of the second guide beam.

18. The method of claim 17, wherein the elevator system further comprises a first guide rail extending vertically through the elevator shaft, the first guide rail comprising a first section of the first guide rail, and
wherein the method further comprises:
removably attaching a second section of the first guide rail to the first lifting system of the beam climber assembly pod, wherein the beam climber system moves the beam climber assembly pod to a location in the elevator shaft where the second section of the first guide rail may be attached to a first section of the first guide rail.

19. The method of claim 15, wherein the elevator system further comprises a first guide rail extending vertically through the elevator shaft, the first guide rail comprising a first section of the first guide rail, and
wherein the method further comprises:
removably attaching a second section of the first guide rail to the first lifting system of the beam climber assembly pod, wherein the beam climber system moves the beam climber assembly pod to a location in the elevator shaft where the second section of the first guide rail may be attached to a first section of the first guide rail.

20. The method of claim 19, wherein the elevator system further comprises a second guide rail extending vertically through the elevator shaft, the second guide rail comprising a first section of the second guide rail, and
wherein the method further comprises:
removably attaching a second section of the second guide rail to a second lifting system of the beam climber assembly pod, wherein the beam climber system moves the beam climber assembly pod to a location in the elevator shaft where the second section of the second guide rail may be attached to a first section of the second guide rail.
